(19) United States
(12) Patent Application Publication
(10) Pub. No.: US 2008/0000418 A1
(43) Pub. Date: Jan. 3, 2008

(54) Coating device and coating method

(75) Inventors: Atsushi Ooshima, Haibara-gun (JP); Satoru Matsumoto, Haibara-gun (JP); Yasuhito Naruse, Haibara-gun (JP); Nobuyuki Sone, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/594,763

(22) Filed: Nov. 9, 2006

(30) Foreign Application Priority Data
Jun. 29, 2006 (JP) 2006-179772

(51) Int. Cl. B05C 11/02

(52) U.S. Cl. 118/110; 118/123; 118/118

(57) ABSTRACT

According to the coating device and method of the invention, coating is performed while the coating liquid is sprayed from the coating liquid supply passage toward the lower surface of the web in a form of a curtain to form a fluid wall of the coating liquid between an exit of the coating liquid supply passage and the lower surface of the web, so that entrained air running with the web can be blocked by the fluid wall. The fluid wall can block entrained air, and therefore, allow stable coating without any defect such as a film cut in a coating film even when the web is run at speed high enough to form a film of entrained air on a web surface and coated.

### BACKGROUND OF THE INVENTION

1. Field of the Invention

The present invention relates to a coating device and a coating method, and more particularly to a coating device and a coating method that can stably coat a coating liquid on a web run at high speed with a bar coater.

2. Description of the Related Art

A general lithographic plate is manufactured by dressing at least one surface of a web of pure aluminum or an aluminum alloy, forming an anodic oxide film on the surface as required to form a substrate web, and then coating a photosensitive layer forming liquid or a heat-sensitive layer forming liquid on the dressed surface and drying the liquid to form a photosensitive or heat-sensitive plate making surface.

A bar coater is generally used as a coating device that coats a coating liquid such as a photosensitive layer forming liquid and a heat-sensitive layer forming liquid. The bar coater includes a bar that rotates in contact with a lower surface of a continuously running web, and a coating portion that discharges the coating liquid to an upstream side of the bar in a running direction of the web to form a coating liquid reservoir, and coats the coating liquid on the lower surface of the web. An SLB type bar coater (see Japanese Utility Model Application Laid-Open No. 02-048167) including a first sheathing board on an upstream side of a bar, or a PBS type bar coater (see Japanese Examined Application Publication No. 58-004589) including a second sheathing board on a downstream side of a bar are also generally used.

However, in these coating devices, increasing running speed of a substrate web causes a film of air running with the substrate web (hereinafter referred to as entrained air) to be formed on a surface of the web, the film of the entrained air is brought into a coating liquid reservoir to cause a defect such as a film cut in a coating film, thereby preventing stable coating.

In order to solve such a problem, in Japanese Patent Application Laid-Open No. 2002-192050, a sheathing board is provided on an upstream side of a coating liquid reservoir to generate a flow of a coating liquid along a web. This prevents air entrained on a surface of the web from being brought into the coating liquid reservoir, and allows stable coating.

### SUMMARY OF THE INVENTION

However, the coating device cannot completely prevent the entrained air from being brought into the coating liquid reservoir when the running speed of the web is further increased (increased to, for example, 100 m/min or higher), and may cause a defect such as a film cut.

Also, the conventional coating devices may produce a thick coating portion at the start or finish of coating. Specifically, at the start of the coating, a bar coater that discharges a coating liquid is brought relatively close to a running web to start coating, and at that time, a coating liquid in more than a specified amount is transferred to the web to form the thick coating portion. Similarly, at the finish of the coating, the bar coater is relatively separated from the running web to finish the coating, and at that time, a clearance between the bar and the web is widened and a large amount of coating liquid is transferred to the web to cause thick coating. With such thick coating in the web, the coating liquid insufficiently dries in a downstream drying step, the coating liquid is transferred to a pass roller that guides the web or the like, and the coating liquid is further transferred to the web to produce a defective product.

The present invention is achieved in view of such circumstances, and has an object to provide a coating device and a coating method that allows stable coating without any defect such as a film cut in a coating film even when a web is run at speed high enough to form a film of entrained air on a web surface and coated, and prevents thick coating at the start or finish of coating.

In order to achieve the above described object, a first aspect of the present invention provides a coating device comprising: a bar that rotates in contact with a lower surface of a continuously running web; a coating liquid supply passage that supplies a coating liquid to an upstream side of the bar in a running direction of the web to form a coating liquid reservoir portion; and a sheathing board that is provided on an upstream side of the coating liquid reservoir portion, wherein the coating liquid is coated on the web via the coating liquid reservoir portion and an excess coating liquid is scraped off by the bar, and wherein the coating liquid is sprayed from the coating liquid supply passage toward the lower surface of the web in a form of a curtain to form a fluid wall of the coating liquid between an exit of the coating liquid supply passage and the lower surface of the web.

According to the first aspect of the invention, coating is performed while the coating liquid is sprayed from the coating liquid supply passage toward the lower surface of the web in a form of a curtain to form a fluid wall of the coating liquid between an exit of the coating liquid supply passage and the lower surface of the web, so that entrained air running with the web can be blocked by the fluid wall.

The fluid wall can block entrained air, and therefore, allow stable coating without any defect such as a film cut in a coating film even when the web is run at speed high enough to form a film of entrained air on a web surface and coated.

In a second aspect of the present invention, spray velocity of the coating liquid sprayed from the exit of the coating liquid supply passage toward the lower surface of the web is 2.5 m/min to 50 m/min in the first aspect of the invention.

The reason is that spray velocity of the coating liquid sprayed from the exit of the coating liquid supply passage is preferably 2.5 m/min or more in order to stably form the fluid wall. The spray velocity is also preferably 50 m/min or less because excessive spray velocity causes the web to flutter due to the impulse of the spray.

In a third aspect of the present invention, the fluid wall forms an upstream surface in the coating liquid reservoir portion in the first or second aspect of the invention.

According to the third aspect, the fluid wall forms an upstream end in the coating liquid reservoir portion, so that coating liquid from one coating liquid supply passage can both block entrained air by forming a fluid wall and coat the web via the coating liquid reservoir portion.

In order to achieve the above described object, a fourth aspect of the present invention provides a coating device comprising: a bar that rotates in contact with a lower surface of a continuously running web; a coating liquid supply passage that supplies a coating liquid to an upstream side of the bar in a running direction of the web to form a coating liquid reservoir portion; and a sheathing board that is provided on an upstream side of the coating liquid reservoir portion, wherein the coating liquid is coated on the web via the coating liquid reservoir portion and an excess coating liquid is scraped off by the bar, and wherein an upper end of the sheathing board is formed into an acute wedge in a straight line along the width of the web.

According to the fourth aspect, the tip of the sheathing board is formed into the acute wedge in the straight line along the width of the web. Thus, a contact line in which the web first comes into contact with the coating liquid is formed in a straight line along the width of the web, and in the contact line, the coating liquid passing through a clearance between the web and the upper end of the sheathing board is pressurized. This can effectively prevent entrained air on a surface of the web from being brought into the coating liquid reservoir portion through the contact line, and allows stable coating because entrained air is prevented from being brought into the coating liquid reservoir portion when line speed of the web (i.e. running speed of the web) is increased.

In a fifth aspect of the present invention, a tapered surface for forming the wedge in the sheathing board is formed on a surface upstream of the sheathing board in a web running direction, and an angle α formed by the tapered surface and the web is 45°≦α≦90° in the fourth aspect of the invention.

The angle α thus formed by the tapered surface and the web in the range of 45°≦α≦90° as in the fifth aspect of the invention facilitates the escape of entrained air, which has been blocked at the contact line, downwardly-along the tapered surface, so that the effect of blocking entrained air at the contact line can be further improved. In addition, forming an L-shaped flow of entrained air escaping downwardly from the lower surface of the web along the tapered surface facilitates formation of stable beads of coating liquid in a clearance between the web and the upper end of the sheathing board. This stabilizes a flow of coating liquid passing through the clearance between the web and the upper end of the sheathing board, and subsequently, pressure of a coating liquid reservoir portion, allowing stable coating.

When the fluid wall in the first aspect of the present invention is to be formed to block entrained air, the angle α formed by the tapered surface and the web in the range of 45°≦α≦90° also effectively facilitates formation of stable beads of coating liquid in a clearance between the web and the upper end of the sheathing board.

In a sixth aspect of the present invention, the upper end of the sheathing board is placed in a position nearer to the web than an upstream upper surface of a bar support member that supports the bar in any one of the first to fifth aspects of the invention.

According to the sixth aspect, placing the upper end of the sheathing board in a position nearer to the web than an upstream upper surface of a bar support member helps coating liquid supplied from the coating liquid supply passage to be stored in the coating liquid reservoir portion. This facilitates pressurization of the coating liquid reservoir portion, preventing entrained air from being brought into the coating liquid reservoir portion.

A seventh aspect of the present invention is in the sixth aspect, in relation to a parallel line that passes the upper end of the sheathing board and is in parallel with the web, and when a distance from the web to the parallel line is C1 and a distance from the parallel line to an upstream upper end surface of the bar support member is C2, 0.2≦C1/C2≦5 is satisfied.

According to the seventh aspect, when 0.2≦C1/C2≦5 is satisfied, entrained air can more reliably be prevented from being brought into the coating liquid reservoir portion, and consequences that would otherwise result from high-speed coating can be avoided. In this case, an excessively narrow clearance C1 between the upper end of the sheathing board and the web may cause scratches on the web contacting the upper end of the sheathing board due to small vibrations and the like of the web: therefore, it is preferable that C1 is not less than 0.1 mm. The relationship of 0.2≦C1/C2≦5 should be satisfied in the sheathing board and the upstream upper surface of the bar support member in their entirety.

In an eighth aspect of the present invention, the upper end of the bar is placed in a higher position than the upper end of the sheathing board in any one of the first to: seventh aspects of the invention.

According to the eighth aspect, the upper end of the bar is placed in a higher position than the upper end of the sheathing board: that is, the height difference H between the upper end position of the bar and the upper end of the sheathing board is positive. This allows an excess coating liquid scraped off by the bar to flow oppositely from a flow of entrained air, more effectively preventing entrained air from being brought into the coating liquid reservoir portion.

In a ninth aspect of the present invention, when an angle of approach of the web to the bar before the start of coating is θ3 with respect to a horizontal surface and an angle formed by a line connecting the upper end of the bar with the upper end of the sheathing board is β with respect to a horizontal surface, θ3<β is satisfied in any one of the first to eighth aspect of the invention.

According to the ninth aspect, because θ3<β is satisfied, the bar is brought into contact with the web earlier than the coating liquid reservoir portion when the coating device is raised toward the web to start coating, and the bar is removed from the web later than the coating liquid reservoir portion when the coating device lowered and removed from the web to end coating. This can prevent thick coating at the start or finish of coating.

In a tenth aspect of the present invention, when an angle of approach of the web to the bar in the course of coating is ƒ1 with respect to a horizontal surface, and an angle formed by the upstream upper surface of the bar support member with respect to a horizontal surface is γ, 0.5≦θ1/γ≦2 is satisfied in the ninth aspect of the invention.

According to the tenth aspect, the upstream upper surface of the bar support member and an angle of approach of the web are preferably in parallel with each other; that is θ1/γ=1: however, there would be no problem within a range of 0.5≦θ1/γ≦2. It is difficult to perform high-speed coating outside the range.

In an eleventh aspect of the present invention, when a coating width of the coating liquid coated on the web is L and a vertical section area of the coating liquid reservoir portion vertically cut, in a web running direction, in an area surrounded by the web, the sheathing board, the upstream upper end surface of the bar support member, and the bar is S, S/L≦0.15 mm is satisfied in any one of the sixth to tenth aspects of the invention.

According to the eleventh aspect, with an excessively large vertical section area S of the coating liquid reservoir portion with respect to a coating width L, the coating liquid reservoir portion is not easily pressurized, as well as being pressurized unevenly. This makes it difficult to perform high-speed coating.

In order to achieve the above described object, a twelfth aspect of the present invention provides a coating method for a coating device including: a bar that rotates in contact with a lower surface of a continuously running web; a coating liquid supply passage that supplies a coating liquid to an upstream side of the bar in a running direction of the web to form a coating liquid reservoir portion; and a sheathing board that is provided on an upstream side of the coating liquid reservoir portion, and generates a flow of the coating liquid along the web between the sheathing board and the web, wherein the coating liquid is coated on the web via the coating liquid reservoir portion and an excess coating liquid is scraped off by the bar, the method comprising: performing coating while the coating liquid is sprayed from the coating liquid supply passage toward the web in a form of a curtain to form a fluid wall that blocks entrained air running with the web.

The twelfth aspect constitutes a method according to the present invention, and coating is performed while the coating liquid is sprayed from the coating liquid supply passage toward the web in a form of a curtain to form a fluid wall that blocks entrained air running with the web. This allows stable coating without any defect such as a film cut in a coating film even when the web is run at speed high enough to form a film of entrained air on a web surface and coated.

In an thirteenth aspect of the present invention, spray velocity of the coating liquid sprayed from the exit of the coating liquid supply passage toward the lower surface of the web is 2.5 m/min to 50 m/min in the twelfth aspect of the invention.

The reason is that spray velocity of the coating liquid sprayed from the exit of the coating liquid supply passage is preferably 2.5 m/min or more in order to stably form the fluid wall. The spray velocity is also preferably 50 m/min or less because excessive spray velocity causes the web to flutter due to the impulse of the spray.

In an fourteenth aspect of the present invention, when fluid pressure at the exit of the coating liquid supply passage is P and atmospheric pressure is P0, P/P0>1.1 is satisfied in the twelfth or thirteenth aspect of the invention.

According to the fourteenth aspect, pressure is raised in the coating liquid reservoir portion so that fluid pressure P at the exit of the coating liquid supply passage with respect to atmospheric pressure P0 is more than 1.1: this can effectively prevent entrained air from being brought into the coating liquid reservoir portion.

In a fifteenth aspect of the present invention, an upper end of the sheathing board is formed into an acute wedge in a straight line along the width of the web in any one of the twelfth to fourteenth aspects of the invention.

According to the fifteenth aspect, the tip of the sheathing board is formed into the acute wedge in the straight line along the width of the web. Thus, a contact line in which the web first comes into contact with the coating liquid is formed in a straight line along the width of the web, and in the contact line, the coating liquid passing through a clearance between the web and the sheathing board is pressurized. This can effectively prevent entrained air on a surface of the web from being brought into the coating liquid reservoir portion through the contact line, and allows stable coating when line speed of the web (i.e. running speed of the web) is increased.

In a sixteenth aspect of the present invention, a tapered surface for forming the wedge in the sheathing board is formed on a surface upstream of the sheathing board in a web running direction, and an angle α formed by the tapered surface and the web is 45°≦α≦90° in the fifteenth aspect of the invention.

According to the sixteenth aspect, the angle α thus formed by the tapered surface and the web in the range of 45°≦α≦90° facilitates the escape of entrained air, which has been blocked at the contact line, downwardly along the tapered surface, so that the effect of blocking entrained air at the contact line can be further improved. In addition, forming an L-shaped flow of entrained air escaping downwardly from the lower surface of the web along the tapered surface facilitates formation of stable beads of coating liquid in a clearance between the web and the sheathing board. This stabilizes a flow of coating liquid passing through the clearance between the web and the sheathing board, and subsequently, pressure of a coating liquid reservoir portion, allowing stable coating.

When the fluid wall in the first aspect of the present invention is to be formed to block entrained air, the angle α formed by the tapered surface and the web in the range of 45°≦α≦90° also effectively facilitates formation of stable beads of coating liquid in a clearance between the web and the upper end of the sheathing board.

In a seventeenth aspect of the present invention, the bar is brought into contact with the web earlier than the upper end of the sheathing board at the start of coating when the coating device is raised to start coating in any one of the twelfth to fifteenth aspects of the invention. This can prevent thick coating at the start of coating.

In an eighteenth aspect of the present invention, the bar is moved away from the web later than the upper end of the sheathing board at the finish of coating when the coating device is lowered to end coating in any one of the twelfth to seventeenth aspects of the invention. This can prevent thick coating at the finish of coating.

The use of the coating device and the coating method according to the present invention is not limited to the manufacture of lithographic plates, but the coating device and the coating method may be used in coating with a bar such as the manufacture of photosensitive materials such as photographic films, the manufacture of magnetic recording materials such as recording tapes, and the manufacture of painted sheet metal such as colored iron sheet. Thus, the web includes, besides a substrate web described in Description of the Related Art, base materials of metal, plastic or paper having a continuous band shape and flexibility such as lithographic plate webs in which a photosensitive or heat-sensitive plate making surface is formed on a dressed surface of a substrate web, base materials for photographic films, baryta paper for photographic paper, base materials for recording tapes, base materials for video tapes, and base materials for floppy® disks. The coating liquid includes solutions used for being coated on a web and dried to form a film, and specifically includes, besides a photosensitive layer forming liquid and a heat-sensitive layer forming liquid, an intermediate layer forming liquid used for forming an intermediate layer on a surface of the web to improve adhesion of a plate making layer, a polyvinyl alcohol water solution used for forming an anodic oxide film that protects a plate making surface of a lithographic plate web from oxidation, a photosensitive colloidal liquid for photographic films used for forming photosensitive layers of photographic films, a photosensitive colloidal liquid for photographic paper used for forming photosensitive layers of photographic paper, a magnetic layer forming liquid used for forming magnetic layers of recording tapes, video tapes, and floppy disks, and various paints used for painting metal.

According to the coating device and the coating method of the present invention, stable coating is allowed without any defect such as a film cut in a coating film even when the web is run at speed high enough to form a film of entrained air on a web surface and coated, and thick coating can be prevented at the start or finish of coating.

### BRIEF DESCRIPTION OF THE DRAWINGS

FIG. 1 is a perspective view of a configuration of a coating device according to an embodiment of the present invention;

FIG. 2 is a sectional view of the coating device in FIG. 1;

FIG. 3 is a schematic diagram of characteristic parts of the coating device of the present invention; and

FIGS. 4A to 4C illustrate operations of the coating device in FIG. 1.

### DETAILED DESCRIPTION OF THE PREFERRED EMBODIMENTS

Now, a preferred embodiment of a coating device and a coating method according to the present invention will be described with reference to the accompanying drawings.

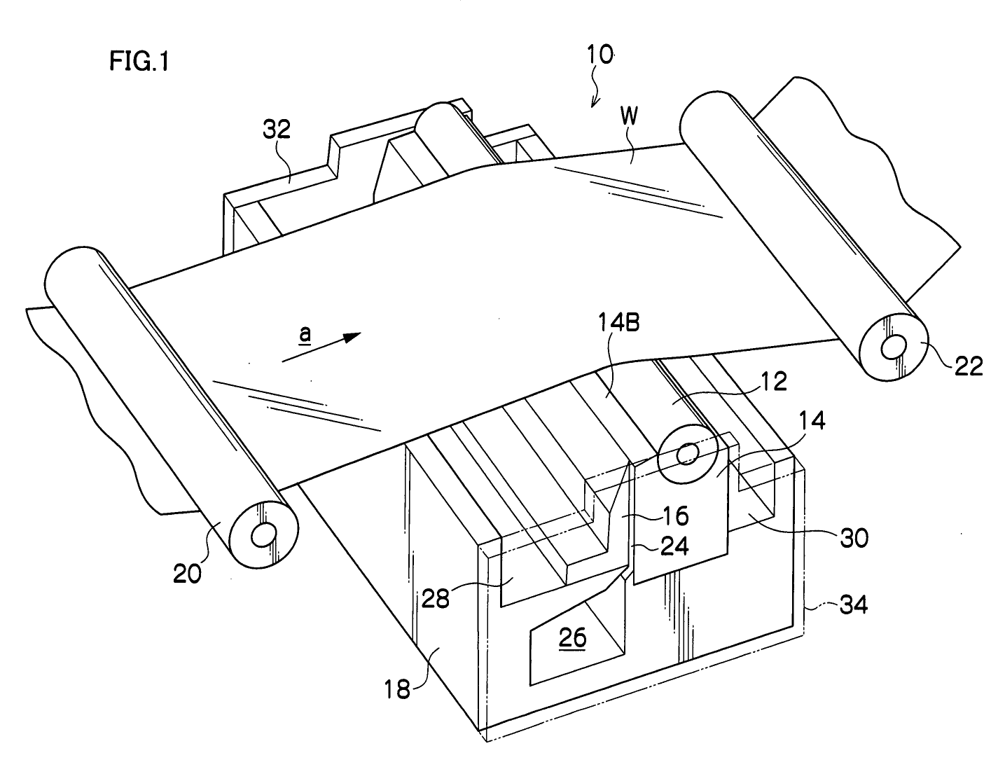

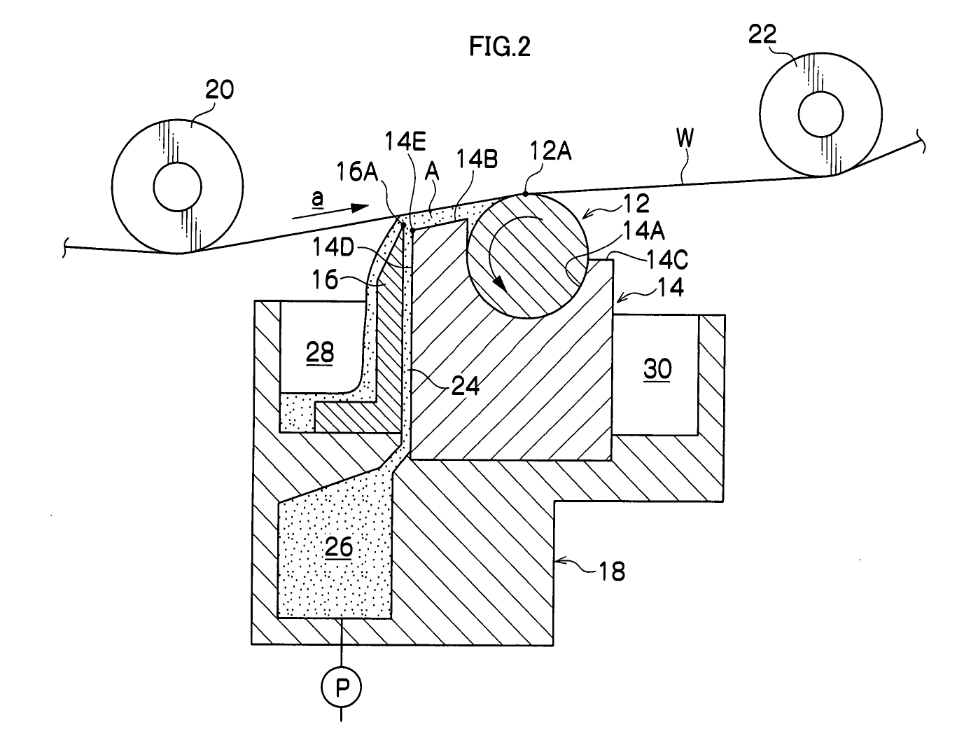

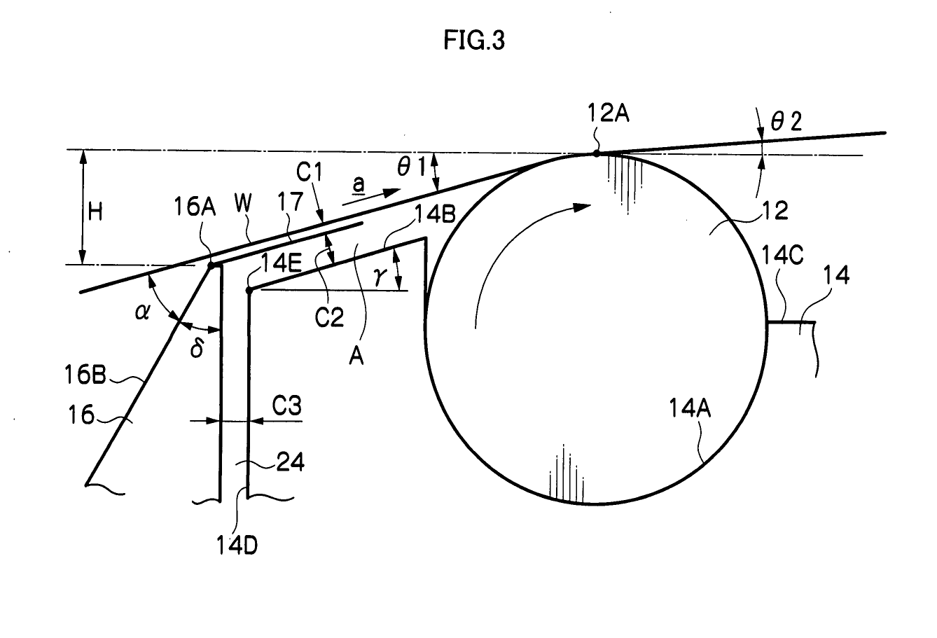

FIGS. 1 and 2 show a configuration of a coating device according to an embodiment of the present invention. FIG. 3 shows a configuration of a coating portion. As shown in these figures, a coating device 10 which is a bar-coating type coating device, performs coating on a lower surface of a running web W, and mainly includes a bar 12, a bar support member 14, a sheathing board 16, and a base 18. The web W is wound around pass rollers 20 and 22 and runs in the direction of arrow a.

The bar 12 is formed into a cylindrical shape, and rotatably supported by the bar support member 14. The bar 12 rotates around an axis in contact with the lower surface of the running web W. The rotational direction of the bar 12 is preferably opposite the running direction a of the web W, and the circumferential velocity of the bar 12 is set to 1% or lower of the running speed of the web W. The rotational direction of the bar 12 may be the same as the running direction a.

The bar 12 may have a smoothly finished surface, have grooves at circumferentially equally spaced intervals, or have a wire tightly wound therearound. The diameter of the wire wound around the bar 12 is preferably 0.07 to 1 mm, and more preferably 0.07 to 0.4 mm. For a bar having grooves or having a wire wound therearound, the depth of the grooves or the thickness of the wire is reduced to reduce a coating thickness of a photosensitive layer forming liquid, and the depth of the grooves or the thickness of the wire is increased to increase the coating thickness of the photosensitive layer forming liquid.

The diameter of the bar 12 is preferably 6 to 25 mm in terms of manufacture because vertical streaks rarely occur in a coating film of the photosensitive layer forming liquid formed on the web W. The bar 12 generally has a length longer than the width of the web W, but may have the length equal to the width of the web W.

The web W comes into contact with the bar 12 with tension at a predetermined lap angle. An angle θ1 formed by the web W on an upstream side and a horizontal surface (an angle of approach) is preferably 3° to 30°, and more preferably 5° to 10°. The angle of approach θ1 is set within such a range to prevent thick coating at the start and finish of coating and prevent friction of the bar 12 as described later. An angle θ2 formed by the web W on a downstream side and the horizontal surface (an ejection angle) is not limited, but set so that the lap angle calculated from θ1 and θ2 becomes a predetermined value.

The bar support member 14 is formed by assembling a plurality of blocks, and has an upper surface formed with an arcuate groove 14A. The bar 12 engages the groove 14A and is rotatably supported by the groove 14A. On an upstream side of the groove 14A in the running direction a of the web W (hereinafter, simply referred to as an upstream side), an upstream upper surface 14B inclined to the horizontal surface is formed. When an angle formed by the upstream upper surface 14B with respect to the horizontal surface is γ (see FIG. 3), 0.5≦θ1/γ≦2 is preferably satisfied in relation to the angle of approach θ1 of the web. The reason is that the upstream upper surface 14B and the web are preferably in parallel with each other; that is θ1/γ=1: however, high-speed coating may be performed within the range of 0.5≦θ1/γ≦2 without any defect such as a scratch failure or a film cut (hereinafter, simply referred to as a defective coating).

On a downstream side of the groove 14A in the running direction a of the web W (hereinafter, simply referred to as a downstream side), a downstream upper surface 14C is formed. The downstream upper surface 14C is formed in a lower position than the upstream upper surface 14B. A wall surface 14D on an upstream side of the bar support member 14 is vertically formed, and the sheathing board 16 is placed to face the wall surface 14D on an upstream side thereof.

The sheathing board 16 is a plate-like member vertically provided, and has a lower end secured to the base 18. As shown in FIG. 3, the sheathing board 16 is formed into an acute wedge in its upper end (a tip) 16A: that is, in the sheathing board 16, a tapered surface 16B for forming the wedge is formed on a surface upstream of the sheathing board 16 in a web running direction so that the wedge tapers toward the upper end 16A in the vertical section.

The upper end 16A of the sheathing board 16 is formed in a straight line along the width of the web W, and parallelism of the upper end is set within 0.01 mm to 0.2 mm. Smaller parallelism increases advantages described later but increases machining costs, and thus the parallelism is preferably 0.01 mm or more, and more preferably 0.05 mm or more.

Because the upper end 16A of the sheathing board 16 is thus formed into an acute wedge in a straight line along the width of the web W, a contact line is formed in a straight line along the width of the web W and coating liquid passing through a clearance between the web W and the upper end 16A of the sheathing board is pressurized. This effectively prevents entrained air on the surface of the web from being brought into the coating liquid reservoir portion A (described in detail below) through the contact line. This allows stable coating without any defective coating when line speed of the web W (i.e. running speed of the web) is increased for high-speed coating.

In addition, it is preferable that an angle α formed by the tapered surface 16B formed in the sheathing board 16 and the web W is in the range of 45°≦α≦90°. The vertex angle δ of the sheathing board 16 may be changed to change the angle α. The angle α thus formed by the tapered surface 16B and the web W in the range of 45°≦α≦90° facilitates the escape of entrained air, which has been blocked at the contact line, downwardly along the tapered surface 16B, so that the effect of blocking entrained air at the contact line can be further improved. In addition, forming an L-shaped flow of entrained air escaping downwardly from the lower surface of the web W along the tapered surface 16B facilitates formation of stable beads of coating liquid in a clearance between the web W and the upper end 16A of the sheathing board 16. This stabilizes a flow of coating liquid passing through the clearance between the web W and the upper end 16A of the sheathing board 16, and subsequently, pressure of a coating liquid reservoir portion A.

As shown in FIG. 3, it is also preferable that in relation to a parallel line 17 that passes the upper end 16A of the sheathing board 16 and is in parallel with the web W, and when a distance from the web W to the parallel line 17 is C1 and a distance from the parallel line 17 to an upstream upper surface 14B of the bar support member 14 is C2, 0.2≦C1/C2≦5 is satisfied. When 0.2≦C1/C2≦5 is satisfied, entrained air can more reliably be prevented from being brought into the coating liquid reservoir portion A, and defective coatings can be prevented from appearing in high-speed coating. In this case, an excessively narrow C1 may cause scratches on the web W contacting the upper end 16A of the sheathing board 16 due to small vibrations and the like of the web W: therefore, it is preferable that C1 is not less than 0.1 mm. The relationship of 0.2≦C1/C2≦5 should be satisfied in the sheathing board 16 and the upstream upper surface 14B of the bar support member 14 in their entirety.

The upper end 12A of the bar 12 is preferably placed in a higher position than the upper end 16A of the sheathing board 16: that is, the height difference H between the upper end 12A of the bar 12 and the upper end 16A of the sheathing board 16 is positive. The upper end 12A of the bar 12 thus placed in a higher position than the upper end 16A of the sheathing board 16 allows an excess coating liquid scraped off by the bar 12 to flow in the direction from the bar 12 to the sheathing board 16. This allows the coating liquid to flow oppositely from the direction of entrained air brought in, more effectively preventing entrained air from being brought into the coating liquid reservoir portion A.

The sheathing board 16 is provided in parallel with the wall surface 14D of the bar support member 14 with a predetermined clearance, and a slit-like supply channel 24 is formed therebetween. The slit width C3 of the supply channel 24 is preferably narrow because discharge pressure can be increased without changing a supply amount of the coating liquid (the photosensitive layer forming liquid).

As shown in FIGS. 1 and 2, the supply channel 24 communicates with a temporary storage chamber 26 provided inside the base 18. The temporary storage chamber 26 is connected to a discharge side of a pump P that supplies the photosensitive layer forming liquid (hereinafter referred to as the coating liquid) from a storage tank (not shown) of the coating liquid, and the pump P is driven to supply the coating liquid to the temporary storage chamber 26.

The temporary storage chamber 26 has the function of temporarily storing the supplied coating liquid, and preventing changes in flow rate of the coating liquid supplied from the supply channel 24 when a discharge amount of the pump P changes. The coating liquid supplied to the temporary storage chamber 26 flows through the supply channel 24 from the lower end to the upper end, and is discharged from the exit in the upper end of the supply channel 24 toward the lower surface of the web W. This forms the coating liquid reservoir portion A in a space surrounded by the lower surface of the web W, the upstream upper surface 14B of the bar support member 14, the bar 12, and the sheathing board 16. The coating liquid in the coating liquid reservoir portion A adheres to the surface of the web W, and thus coating is performed. In this case, when a coating width of the coating liquid coated on the web W is L and a vertical section area of the coating liquid reservoir portion A vertically cut in a web running direction is S, it is preferable that S/L≦0.15 mm is satisfied. The reason is that, with an excessively large vertical section area S of the coating liquid reservoir portion A with respect to a coating width L, the coating liquid reservoir portion A is not easily pressurized, as well as being pressurized unevenly.

The supply amount of the coating liquid is set according to running speed L (m/min) of the web W. The spray velocity of the coating liquid sprayed from the exit of the supply channel 24 toward the lower surface of the web W in a form of a curtain is preferably 2.5 m/min to 50 m/min. This forms a fluid wall of the sprayed coating liquid between the exit of the supply channel 24 and the lower surface of the web W, and the fluid wall can block entrained air. When the fluid wall is to be formed, it is also preferable that an angle α formed by the tapered surface 16B formed in the sheathing board 16 and the web W is in the range of 45°≦α≦90°.

As shown in FIG. 2, the base 18 includes an overflow liquid reservoir 28 on an upstream side of the sheathing board 16, and the overflow liquid reservoir 28 can receive a coating liquid flowing over the upper end 16A of the sheathing board 16 to the upstream side. The base 18 includes an overflow liquid reservoir 30 on a downstream side of the bar support member 14, and the overflow liquid reservoir 30 can receive a coating liquid flowing over to the downstream side without adhering to the web W out of the coating liquid in the coating liquid reservoir A. The coating liquids received in the overflow liquid reservoirs 28 and 30 are preferably returned to the storage tank (not shown) by return pipes (not shown).

As shown in FIG. 1, side plates 32 and 34 are provided at opposite edges of the base 18, and the side plates 32 and 34 form side walls of the overflow liquid reservoirs 28 and 30, the supply channel 24, and the temporary storage chamber 26.

The base 18 is supported by an unshown hoisting and lowering device, and is movable along the height. Thus, the bar 12 can be moved toward the web W (that is, moved upward) and brought into contact with the web W, or the bar 12 can be moved away from the web W (that is, moved downward) and separated from the web W. The running position of the web W may be changed by hoisting or lowering the pass rollers 20 and 22 instead of moving the base 18.

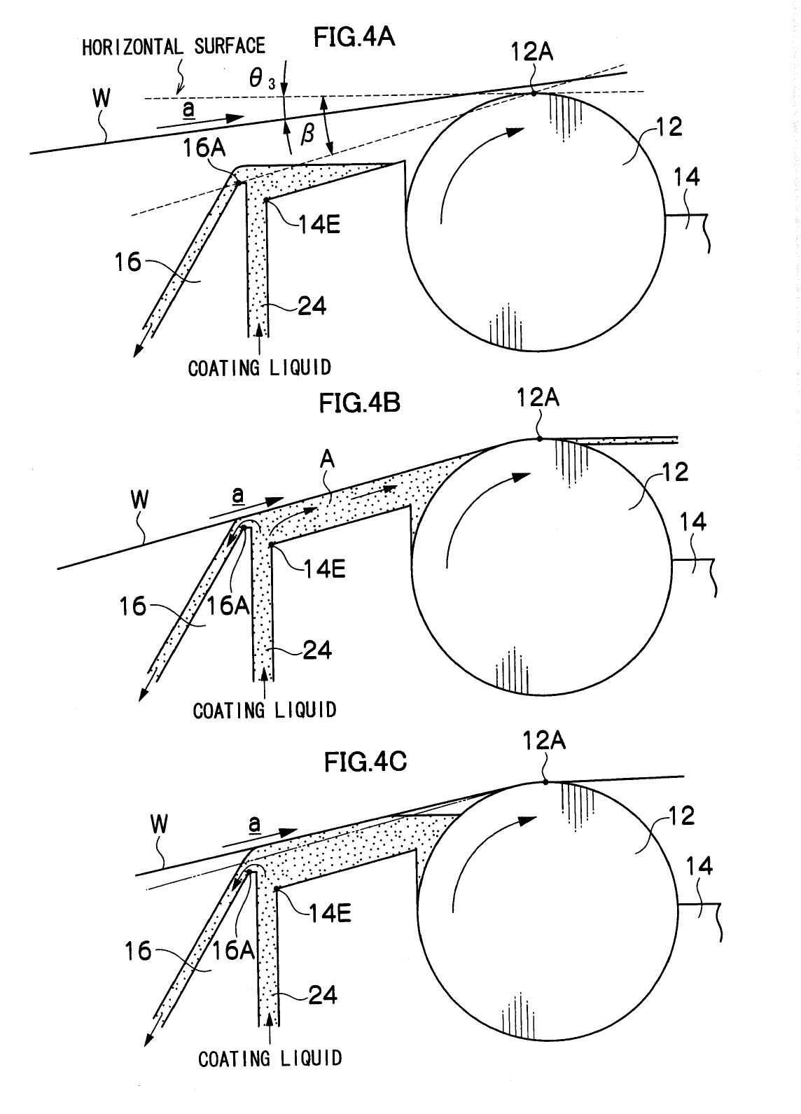

Next, operations of the coating device 10 according to the invention thus configured will be described with reference to FIGS. 4A to 4C.

Before the start of the coating, the web W and the bar 12 are apart as shown in FIG. 4A.

Before the start of the coating, it is preferable that θ3<β is satisfied in terms of the relationship between an angle of approach θ3 of the web W and an angle β formed by a line connecting the upper end 12A of the bar 12 with the upper end 16A of the sheathing board 16 with respect to a horizontal surface.

In this state, the web W is run in the running direction a, the bar 12 is rotated in the direction of arrow, and the coating liquid is discharged from the supply channel 24. At this time, the upper end 16A of the sheathing board 16 is placed in the higher position than the upstream upper end 14E in the upstream upper surface 14B of the bar support member 14, and thus the coating liquid discharged from the supply channel 24 is stored in the discharge port of the supply channel 24. Further, the upper end 12A of the bar 12 is placed in the higher position than the upper end 16A of the sheathing board 16, and thus the supplied coating liquid flows over the upper end 16A of the sheathing board 16 to the upstream side. This prevents the coating liquid from flowing over the bar 12 to the downstream side.

At the start of the coating, the base 18 (see FIG. 2) is first hoisted. Thus, the lap angle of the web W to the bar 12 gradually increases, and the web W finally laps on the bar 12 as shown by a dash-double-dot line in FIG. 4A. At this time, the distance between the web W and the upper end 16A of the sheathing board 16 is extremely small, and thus the coating liquid supplied from the supply channel 24 is stored in the space surrounded by the sheathing board 16,-the bar support member 14, the bar 12, and the web W to form the coating liquid reservoir portion A as shown in FIG. 4B. Then, when the space is filled-with the coating liquid, the internal pressure of the coating liquid reservoir portion A is increased, and coating on the web W is performed. Specifically, most of the coating liquid that forms the coating liquid reservoir A adheres to the web W and is moved in the running direction a of the web W, and is scraped off by the bar 12. Thus, a measured amount of coating liquid remains on the web W, and thus a coating liquid of a predetermined thickness is coated on the web W.

When such coating liquid is coated on the web W, it is preferable that the spray velocity of the coating liquid sprayed from the exit of the supply channel 24 is 2.5 m/min to 50 m/min and the coating liquid is sprayed from the supply channel 24 toward the lower surface of the web W in a form of a curtain. The reason is that this can form a fluid wall of the coating liquid between the exit of the supply channel 24 and the lower surface of the web W, and the fluid wall can also block entrained air.

In this case, the fluid wall forms an upstream end in the coating liquid reservoir portion A, so that coating liquid from one supply channel 24 can both form a fluid wall and coat the web via the coating liquid reservoir portion A.

On the other hand, because the upper end 12A of the bar 12 is placed in a higher position than the upper end 16A of the sheathing board 16, an excess coating liquid scraped off by the bar 12 flows in the direction opposite to the running direction a, and flows down over the upper end 16A of the sheathing board 16. This flow of the coating liquid generates dynamic pressure in the direction opposite to the running direction a, and thus a film of entrained air carried with the web W in the running direction a is forced out to the upstream side at the position of the upper end 16A of the sheathing board 16. This prevents the film of the entrained air from being brought into the coating liquid reservoir A.

In the embodiment, the upper end 16A of the sheathing board 16 is formed into an acute wedge, thus a portion in which the web W first comes into contact with the coating liquid (hereinafter referred to as a contact line) is formed in a straight line along the width of the web W, and in the contact line, the coating liquid passing through the clearance between the web W and the sheathing board 16 is significantly pressurized. This can effectively prevent the entrained air on the surface of the web W from being brought into the coating liquid reservoir through the contact line. Such a configuration also allows the internal pressure of the coating liquid reservoir A to be increased. Specifically, when the upper end of the sheathing board 16 is formed into a flat shape or an arcuate shape as is conventional, the increase in the internal pressure of the coating liquid reservoir A causes uneven pressure along the width in the clearance between the sheathing board and the web, and the entrained air is easily brought into the liquid reservoir, but this can be prevented by the embodiment.

In the embodiment, when a coating width of the coating liquid coated on the web W is L and a vertical section area of the coating liquid reservoir portion vertically cut in a web running direction is S, S/L≦0.15 mm is satisfied, thereby increasing the internal pressure of the coating liquid reservoir portion A, and effectively preventing entrained air from being brought into the coating liquid reservoir portion A. This can reliably prevent entrained air from being brought into the liquid reservoir even if the running speed L of the web W is increased to cause the entrained air to be easily brought into the liquid reservoir.

The embodiment can also prevent thick coating at the start of the coating.

Specifically, before the start of the coating, because θ3<β is satisfied and the upper end 12A of the bar 12 is placed in a higher position than the upper end 16A of the sheathing board 16, the upper end 12A of the bar 12 first comes into contact with the web W, and thereafter, the upper end 16A of the sheathing board 16 is brought close to the web W to form the coating liquid reservoir portion A, thereby starting the coating. This can eliminate an excess coating liquid insufficiently: scraped off by the bar 12 and prevent thick coating at the start of coating.

In addition, before the start of the coating, the coating liquid-flows over the upper end 16A of the sheathing board 16 down to the upstream side, and the web W is run in a specified position (that is, the position along the dash-double-dot line) to increase the internal pressure of the coating liquid reservoir portion A, and the coating is started. Thus, the coating is not started before the internal pressure of the coating liquid reservoir portion A increases, thereby preventing thick coating at the start of the coating. Specifically, if the coating is started before the increase in the internal pressure of the coating liquid reservoir portion A, the web W passes through the bar 12 with the coating liquid having adhered to the web W being insufficiently scraped off by the bar 12, possibly causing thick coating, but this can be prevented by the embodiment. Thus, the coating liquid coated on the web W can be reliably dried in a downstream drying device, thereby preventing problems caused by transfer of an undried coating liquid as at the occurrence of thick coating. Thus, according to the embodiment, thick coating at the start of the coating can be prevented.

At the finish of the coating, the base 18 (see FIG. 1) is first lowered. Thus, as shown in FIG. 4C, the lap angle of the web W to the bar 12 gradually decreases to increase the clearance between the web W and the upper end 16A of the sheathing board 16. In this case, because the upper end 12A of the bar 12 is placed in a higher position than the upper end 16A of the sheathing board 16 as with the case before the start of the coating, the flow rate of the coating liquid that flows over the upper end 16A of the sheathing board 16 out of the coating liquid in the coating liquid reservoir portion A gradually increases, and the coating liquid adhering to the web W and carried gradually decreases. Then, the web W is separated from the coating liquid reservoir portion A, and separated from the bar 12 after the coating liquid adhering to the web W and carried runs out. This allows the coating to be finished without causing thick coating on the web W. Specifically, for the conventional example, the clearance between the bar 12 and the web W is increased substantially at the same time as the base 18 is lowered, and a large amount of coating liquid adheres to the web W and is carried at the finish of the coating to cause thick coating, but this can be prevented by the embodiment.

### EXAMPLES

One surface of an aluminum web having a width of 1 m was roughened, then anodic oxidation was performed to manufacture a substrate web W. A photosensitive substance, a binder, an activator, a dye, and a viscosity improver were dissolved in an organic solvent to prepare photosensitive layer forming liquids. The photosensitive layer forming liquids having the viscosity of 25 cp and the viscosity of 50 cp were prepared. Then, the bar coater 10 in FIGS. 1 and 2 was used, tension of 100 kg/m was applied to the web W, the bar 12 was rotated in the direction opposite to the running direction a of the web W at speed of 5 rpm, and the photosensitive layer forming liquid was coated. The viscosity of the photosensitive layer forming liquid was 1 to 25 mPa·s, and the coating amount thereof was 15 to 22 cc/m². These conditions are the same throughout the examples described below.

### Example 1

In Example 1, an examination was conducted to determine how an angle α formed by the tapered surface 16B of the sheathing board 16 and the web W affects speed at which no defective coating occurs (coating limit speed). The angle α was changed by the vertex angle δ of the sheathing board 16 while the angle of approach θ1 was constant. The slit width in the direction of web width of the supply channel 24 was 1 m, and the slit clearance was 0.5 mm. The test results are shown in Table 1.

As a result, as can be seen from Tests 1 to 5, with the increase of the angle α from 5°, the coating limit speed is also increased. Specifically, when the angle α was 5° in Test 1, the coating limit speed was 70 m/min: however, it reached the maximum, or 150 m/min, when the angle α was 45° in Test 3, and the maximum was maintained up to 80° of the angle α in Test 5. Although tests were not conducted on the angle α of more than 80°, the maximum may be considered to remain up to near 90° that is a limit for fabrication of the sheathing board. Therefore, the preferred range of the angle α is preferably 45°≦α≦90°.

TABLE 1

| | | vertex angle | | | | |
|---|---|---|---|---|---|---|
| | angle of | of the | | viscosity | coating | coating |
| | approach | sheathing | | of the liquid | amount (W) | limit speed |
| | (θ1) | board (δ) | angle α | (mPa · s) | (cc/m²) | (m/min) |
| Test 1 | 5° | 80° | 5° | 1 to 25 | 22 to 15 | 70 |
| Test 2 | 5° | 70° | 15° | 1 to 25 | 22 to 15 | 100 |
| Test 3 | 5° | 40° | 45° | 1 to 25 | 22 to 15 | 150 |
| Test 4 | 5° | 30° | 55° | 1 to 25 | 22 to 15 | 150 |
| Test 5 | 5° | 5° | 80° | 1 to 25 | 22 to 15 | 150 |

### Example 2

In Example 2, a relationship between C1/C2 and the coating limit speed was examined, where in relation to a parallel line 17 that passes the upper end 16A of the sheathing board 16 and is in parallel with the web W, C1 is a distance from the web W to the parallel line 17 and C2 is a distance from the parallel line 17 to an upstream upper surface 14B of the bar support member 14. The slit width in the direction of web width of the supply channel 24 was 1 m, and the slit clearance was 0.5 mm. The test results are shown in Table 2.

| | | | | | | viscosity of the | coating | coating |
|---|---|---|---|---|---|---|---|---|
| | | | | | | liquid | amount (W) | limit speed |
| | C2 | | C1 | | C1/C2 | (cp) | (cc/m²) | (m/min) |
| Test 6 | 0.05 | mm | 0.5 | mm | 10 | 1 to 25 | 22 to 15 | 100 |
| Test 7 | 0.1 | mm | 0.5 | mm | 5 | 1 to 25 | 22 to 15 | 150 |
| Test 8 | 0.4 | mm | 0.5 | mm | 1.25 | 1 to 25 | 22 to 15 | 200 |
| Test 9 | 2 | mm | 0.5 | mm | 0.25 | 1 to 25 | 22 to 15 | 160 |
| Test 10 | 3 | mm | 0.5 | mm | 0.17 | 1 to 25 | 22 to 15 | 150 |
| Test 11 | 4 | mm | 0.5 | mm | 0.13 | 1 to 25 | 22 to 15 | 100 |
| Test 12 | 0.4 | mm | 2 | mm | 5 | 1 to 25 | 22 to 15 | 100 |
| Test 13 | 0.4 | mm | 0.08 | mm | 0.2 | 1 to 25 | 22 to 15 | scratches |
| Test 14 | 0.4 | mm | 0.1 | mm | 0.25 | 1 to 25 | 22 to 15 | 160 |

In Table 2, Tests 6 to 11 show the relationship between C1/C2 and the coating limit speed, and Tests 12 to 14 were conducted to determine how narrow the clearance distance C1 can be between the web W and the upper end 16A of the sheathing board 16.

From the results in Table 2, the coating limit speed increases with the reduction of C1/C2: however, the coating limit speed tends to decrease again with excessively small C1/C2. Specifically, when C1/C2 was in the range of 0.17 to 5, the coating limit speed was 150 to 200 m/min and high-speed coating could be performed. Therefore, high-speed coating can be performed without any defective coating within the range of 0.2≦C1/C2≦5.

The Tests 12 to 14 was conducted using the value of C2 in Test 8 whose coating limit speed was the largest among Tests 6 to 12. As can be seen from Test 13, with excessively narrow C1, the web W was brought into contact with the upper end 16A of the sheathing board 16, causing scratches on the web W. However, when C1 is 0.1 mm as shown in Test 14, the coating limit speed increases without scratches on the web W, and therefore, it is required that C1 is not less than 0.1 mm. Incidentally, with excessively large C1 as shown in Test 12, the pressure in the coating liquid reservoir portion A is not easily raised and the coating limit speed tends to decrease.

### Example 3

In Example 3, a relationship between the difference H between the height of the upper end 12A of the bar 12 and the height of the upper end 16A of the sheathing board 16 and the coating limit speed was examined. The distance C1 between the web W and the upper end 16A of the sheathing board 16 was consistently 0.5 mm. The slit width in the direction of web width of the supply channel 24 was 1 m, and the slit clearance was 0.5 mm. The test results are shown in Table 3.

TABLE 3

| | | | | viscosity of | | coating |
|---|---|---|---|---|---|---|
| | | | | the | coating | limit |
| | | | | liquid | amount (W) | speed |
| | H | | C1 | (MPa · s) | (cc/m²) | (m/min) |
| Test 15 | 0.2 | mm | 0.5 mm | 1 to 25 | 22 to 15 | 150 |
| Test 16 | −0.2 | mm | 0.5 mm | 1 to 25 | 22 to 15 | 50 |
| Test 17 | 0 | mm | 0.5 mm | 1 to 25 | 22 to 15 | 70 |

As can be seen from Test 15, when the difference H is a positive value such as 0.2 mm so that the upper end 12A of the bar 12 can be slightly higher than the upper end 16A of the sheathing board 16, the coating limit speed increases to 150 m/min. On the other hand, as can be seen from Tests 16 and 17, when the difference H is zero or a negative value such as −0.2 mm so that both the upper end 12A of the bar 12 and the upper end 16A of the sheathing board 16 have the same height or the upper end 16A of the sheathing board 16 can be slightly higher than the upper end 12A of the bar 12, the coating limit speed decreases to 50 to 70 m/min.

Therefore, It is also preferable that the height difference H between the upper end 12A of the bar 12 and the upper end 16A of the sheathing board 16 is positive to increase the coating limit speed.

### Example 4

In Example 4, an examination was conducted to determine how a relationship between θ3 and β affects thick-coating at the start and finish of coating, where θ3 is an angle of approach of the web W to the bar 12 before the start of coating with respect to a horizontal surface and β is an angle formed by a line connecting the upper end 12A of the bar 12 with the upper end 16A of the sheathing board 16 with respect to a horizontal surface. The slit width in the direction of web width of the supply channel 24 was 1 m, and the slit clearance was 0.5 mm. In this case, the angle β was consistently 20° and the angle of approach θ3 of the web before the start of coating was changed. In Table 4, “Good” indicates occurrence of no thick coating and “Poor” indicates occurrence of thick coating.

TABLE 3

| | angle of | | | |
|---|---|---|---|---|
| | approach θ3 | | | |
| | of the web before | | thick coating | thick coating |
| | the start | | at the | at the |
| | of coating | angle β | start of coating | finish of coating |
| Test 18 | 25° | 20° | Poor | Poor |
| Test 19 | 20° | 20° | Poor | Poor |
| Test 20 | 15° | 20° | Good | Good |
| Test 21 | 10° | 20° | Good | Good |
| Test 22 | 5° | 20° | Good | Good |

Good: Normal
Poor: Unallowable level as product

As a result, as can be seen from Tests 18 to 19, thick coating could not be prevented at both the start and finish of coating when θ3≧β. However, as shown in Tests 20 to 22, satisfying θ3<β could prevent thick coating from occurring at both the start and finish of coating.

### Example 5

In Example 5, preferred spray velocity was examined when the coating liquid was sprayed from the exit of the supply channel 24 toward the lower surface of the web W to form a fluid wall. The spray velocity was changed by changing the slit clearance of the supply channel 24. The test results are shown in Table 5.

TABLE 5

| | spray velocity | | | viscosity | coating | coating |
|---|---|---|---|---|---|---|
| | of the coating | width | slit | of the | amount | limit |
| | liquid | of the | clear- | liquid | (W) | speed |
| | (m/min) | slit | ance | (cp) | (cc/m²) | (m/min) |
| Test 23 | 2.0 | 1 m | 0.7 mm | 1 to 25 | 22 to 15 | 100 |
| Test 24 | 2.5 | 1 m | 0.6 mm | 1 to 25 | 22 to 15 | 150 |
| Test 25 | 3.0 | 1 m | 0.3 mm | 1 to 25 | 22 to 15 | 200 |

As a result, a good fluid wall was formed at spray velocity of 2.5 m/min or more, and the coating limit speed could be increased up to 150 r/min. Although not shown in Table 5, spray velocity more than 50 m/min caused the impulse of the spray that is too strong to perform coating due to fluttering of the web W. Therefore, spray velocity of the coating liquid sprayed from the exit of the supply channel 24 toward the lower surface of the web W is preferably 2.5 m/min to 50 m/min.

### Example 6

In Example 6, an examination was conducted to determine how θ1/γ affects the coating limit speed, where θ1 is an angle of approach of the web W to the bar 12 in the course of coating with respect to a horizontal surface, and γ is an angle formed by the upstream upper surface 14B of the bar support member 14 with respect to a horizontal surface. The slit width in the direction of web width of the supply channel 24 was 1 m, and the slit clearance was 0.5 mm. The test results are shown in Table 6.

TABLE 6

| | angle of | | | viscosity | coating | |
|---|---|---|---|---|---|---|
| | approach | | | of the | amount | coating |
| | of the | | | liquid | (W) | limit speed |
| | web (θ1) | angle γ | θ1/γ | (cp) | (cc/m²) | (m/min) |
| Test 26 | 20 | 5 | 4 | 1 to 25 | 22 to 15 | 100 |
| Test 27 | 20 | 10 | 2 | 1 to 25 | 22 to 15 | 150 |
| Test 28 | 20 | 20 | 1 | 1 to 25 | 22 to 15 | 200 |
| Test 29 | 5 | 20 | 0.25 | 1 to 25 | 22 to 15 | 100 |
| Test 30 | 10 | 20 | 0.5 | 1 to 25 | 22 to 15 | 150 |

As a result, θ1/γ of less than 0.5 or more than 2 could only achieve the coating limit speed on the order of 100 m/min: while θ1/γ defined within a range of 0.5≦θ1/γ≦2 could result in the coating limit speed of 150 to 200 m/min and high-speed coating could be performed.

### Example 7

In Example 7, a relationship between P/P0 and the coating limit speed was examined, where P is fluid pressure at the exit of the supply channel 24 and P0 is atmospheric pressure. The test results are shown in Table 7.

TABLE 7

| | | viscosity of | coating | coating |
|---|---|---|---|---|
| | | the liquid | amount (W) | limit speed |
| | P/P0 | (cp) | (cc/m²) | (m/min) |
| Test 31 | 1 | 1 to 25 | 22 to 15 | 100 |
| Test 32 | 1.1 | 1 to 25 | 22 to 15 | 120 |
| Test 33 | 1.2 | 1 to 25 | 22 to 15 | 150 |

As a result, P/P0 of 1.0 in Test 31 resulted in the coating limit speed of 100 m/min: while P/P0 of 1.1 increased the coating limit speed up to 120 m/min and P/P0 of 1.2 increased the coating limit speed up to 150 m/min. Therefore, P/P0 is preferably 1.1 or more in order to perform high-speed coating so that no defective coating may occur.

### Example 8

In Example 8, a relationship between a ratio of a vertical section area S of the coating liquid reservoir portion A to a coating width L (S/L) and the coating limit speed was examined. In the case of Example 8, the coating width L was consistently 200 mm and the vertical section area S was changed. Therefore, the slit width in the direction of web width of the supply channel 24 was reduced according to the coating width L, and the slit clearance was 0.5 mm as described above. The test results are shown in Table 8.

TABLE 8

| | | | | viscosity | | |
|---|---|---|---|---|---|---|
| | | | | of | coating | coating |
| | S | L | S/L | the liquid | amount (W) | limit speed |
| | (mm²) | (mm) | (mm) | (cp) | (cc/m²) | (m/min) |
| Test 34 | 30 | 200 | 0.15 | 1 to 25 | 22 to 15 | 100 |
| Test 35 | 20 | 200 | 0.10 | 1 to 25 | 22 to 15 | 120 |
| Test 36 | 15 | 200 | 0.08 | 1 to 25 | 22 to 15 | 150 |

As a result, with the reduction of S/L, the coating limit speed tended to increase and was 100 m/min when S/L was 0.15: however, it increased up to 120 m/min when S/L was 0.10 and up to 150 m/min when S/L was 0.08. Therefore, it is preferable that S/L≦0.15 mm is satisfied.

What is claimed is:

1. A coating device comprising:
a bar that rotates in contact with a lower surface of a continuously running web;
a coating liquid supply passage that supplies a coating liquid to an upstream side of said bar in a running direction of said web to form a coating liquid reservoir portion; and
a sheathing board that is provided on an upstream side of said coating liquid reservoir portion,
wherein said coating liquid is coated on said web via said coating liquid reservoir portion and an excess coating liquid is scraped off by said bar, and
wherein the coating liquid is sprayed from said coating liquid supply passage toward the lower surface of said web in a form of a curtain to form a fluid wall of the coating liquid between an exit of said coating liquid supply passage and the lower surface of said web.

2. The coating device according to claim 1, wherein a spray velocity of the coating liquid sprayed from the exit of said coating liquid supply passage toward the lower surface of said web is 2.5 m/min to 50 m/min.

3. The coating device according to claim 1, wherein said fluid wall forms an upstream end in said coating liquid reservoir portion.

4. The coating device according to claim 2, wherein said fluid wall forms an upstream end in said coating liquid reservoir portion.

5. The coating device according to claim 1, wherein the upper end of said bar is placed in a higher position than the upper end of said sheathing board.

6. The coating device according to claim 4, wherein the upper end of said bar is placed in a higher position than the upper end of said sheathing board.

7. The coating device according to claim 1, wherein when an angle of approach of said web to said bar before the start of coating is θ3 with respect to a horizontal surface and an angle formed by a line connecting the upper end of said bar with the upper end of said sheathing board is β with respect to a horizontal surface, θ3<β is satisfied.

8. The coating device according to claim 6, wherein when an angle of approach of said web to said bar before the start of coating is θ3 with respect to a horizontal surface and an angle formed by a line connecting the upper end of said bar with the upper end of said sheathing board is β with respect to a horizontal surface, θ3<β is satisfied.

9. The coating device according to claim 7, wherein when an angle of approach of said web to said bar in the course of coating is θ1 with respect to a horizontal surface, and an angle formed by the upstream upper surface of said bar support member with respect to a horizontal surface is γ, 0.5≦θ1/γ≦2 is satisfied.

10. The coating device according to claim 8, wherein when an angle of approach of said web to said bar in the course of coating is θ1 with respect to a horizontal surface, and an angle formed by the upstream upper surface of said bar support member with respect to a horizontal surface is γ, 0.5≦θ1/γ≦2 is satisfied.

11. A coating device comprising:
a bar that rotates in contact with a lower surface of a continuously running web;
a coating liquid supply passage that supplies a coating liquid to an upstream side of said bar in a running direction of said web to form a coating liquid reservoir portion; and
a sheathing board that is provided on an upstream side of said coating liquid reservoir portion,
wherein said coating liquid is coated on said web via said coating liquid reservoir portion and an excess coating liquid is scraped off by said bar, and
wherein an upper end of said sheathing board is formed into an acute wedge in a straight line along the width of said web.

12. The coating device according to claim 11, wherein a tapered surface for forming the wedge in said sheathing board is formed on a surface upstream of said sheathing board in a web running direction, and an angle α formed by said tapered surface and said web is 45°≦α≦90°.

13. The coating device according to claim 12, wherein the upper end of said sheathing board is placed in a position nearer to said web than an upstream upper surface of a bar support member that supports said bar.

14. The coating device according to claim 13, wherein, in relation to a parallel line that passes the upper end of said sheathing board and is in parallel with said web, and when a distance from said web to said parallel line is C1 and a distance from said parallel line to an upstream upper end surface of said bar support member is C2, 0.2≦C1/C2≦5 is satisfied.

15. The coating device according to claim 11, wherein the upper end of said bar is placed in a higher position than the upper end of said sheathing board.

16. The coating device according to claim 14, wherein the upper end of said bar is placed in a higher position than the upper end of said sheathing board.

17. The coating device according to claim 11, wherein when an angle of approach of said web to said bar before the start of coating is θ3 with respect to a horizontal surface and an angle formed by a line connecting the upper end of said bar with the upper end of said sheathing board is β with respect to a horizontal surface, θ3<β is satisfied.

18. The coating device according to claim 16, wherein when an angle of approach of said web to said bar before the start of coating is θ3 with respect to a horizontal surface and an angle formed by a line connecting the upper end of said bar with the upper end of said sheathing board is β with respect to a horizontal surface, θ3<β is satisfied.

19. The coating device according to claim 17, wherein when an angle of approach of said web to said bar in the course of coating is θ1 with respect to a horizontal surface, and an angle formed by the upstream upper surface of said bar support member with respect to a horizontal surface is γ, 0.5≦θ1/γ≦2 is satisfied.

20. The coating device according to claim 18, wherein when an angle of approach of said web to said bar in the course of coating is θ1 with respect to a horizontal surface, and an angle formed by the upstream upper surface of said bar support member with respect to a horizontal surface is γ, 0.5≦θ1/γ≦2 is satisfied.

21. The coating device according to claim 13, wherein when a coating width of the coating liquid coated on said web is L and a vertical section area of said coating liquid reservoir portion vertically cut, in a web running direction, in an area surrounded by said web, said sheathing board, the upstream upper end surface of said bar support member, and said bar is S, S/L≦0.15 mm is satisfied.

22. The coating device according to claim 20, wherein when a coating width of the coating liquid coated on said web is L and a vertical section area of said coating liquid reservoir portion vertically cut, in a web running direction, in an area surrounded by said web, said sheathing board, the upstream upper end surface of said bar support member, and said bar is S, S/L≦0.15 mm is satisfied.

23. A coating method for a coating device including:
a bar that rotates in contact with a lower surface of a continuously running web;
a coating liquid supply passage that supplies a coating liquid to an upstream side of said bar in a running direction of said web to form a coating liquid reservoir portion; and
a sheathing board that is provided on an upstream side of said coating liquid reservoir portion, and generates a flow of the coating liquid along said web between said sheathing board and said web,
wherein said coating liquid is coated on said web via said coating liquid reservoir portion and an excess coating liquid is scraped off by said bar, the method comprising:
performing coating while the coating liquid is sprayed from said coating liquid supply passage toward said web in a form of a curtain to form a fluid wall that blocks entrained air running with said web.

24. The coating method according to claim 23, wherein a spray velocity of the coating liquid sprayed from the exit of said coating liquid supply passage toward the lower surface of said web is 2.5 m/min to 50 n/min.

25. The coating method according to claim 23, wherein when fluid pressure at the exit of said coating liquid supply passage is P and atmospheric pressure is P0, P/P0>1.1 is satisfied.

26. The coating method according to claim 24, wherein when fluid pressure at the exit of said coating liquid supply passage is P and atmospheric pressure is P0, P/P0>1.1 is satisfied.

27. The coating method according to claim 23, wherein an upper end of said sheathing board is formed into an acute wedge in a straight line along the width of said web.

28. The coating method according to claim 26, wherein an tipper end of said sheathing board is formed into an acute wedge in a straight line along the width of said web.

29. The coating method according to claim 27, wherein a tapered surface for forming the wedge in said sheathing board is formed on a surface upstream of said sheathing board in a web running direction, and an angle α formed by said tapered surface and said web is 45°≦α≦90°.

30. The coating method according to claim 28 wherein a tapered surface for forming the wedge in said sheathing board is formed on a surface upstream of said sheathing board in a web running direction, and an angle α formed by said tapered surface and said web is 45°≦α≦90°.

31. The coating method according to claim 23, wherein said bar is brought into contact with said web earlier than the upper end of said sheathing board at the start of coating when said coating device is raised to start coating.

32. The coating method according to claim 30, wherein said bar is brought into contact with said web earlier than the upper end of said sheathing board at the start of coating when said coating device is raised to start coating.

33. The coating method according to claim 23, wherein said bar is moved away from said web later than the upper end of said sheathing board at the finish of coating when said coating device is lowered to end coating.

34. The coating method according to claim 32, wherein said bar is moved away from said web later than the upper end of said sheathing board at the finish of coating when said coating device is lowered to end coating.
